(19) United States
(12) Patent Application Publication
(10) Pub. No.: US 2025/0034727 A1
(43) Pub. Date: Jan. 30, 2025

(54) ELECTROLYSER

(71) Applicant: BRAMBLE ENERGY LIMITED, Crawley (GB)

(72) Inventors: Thomas James MASON, Crowborough (GB); Maximilian MAIER, Munich (DE)

(21) Appl. No.: 18/712,797

(22) PCT Filed: Nov. 29, 2022
(86) PCT No.: PCT/GB2022/053019

§ 371 Date: May 23, 2024

(30) Foreign Application Priority Data
Nov. 30, 2021 (GB) 2117308.3

(51) Int. Cl. C25B 11/02; C25B 9/23; C25B 9/70; C25B 11/031; C25B 11/056; C25B 11/061; C25B 11/089; C25B 13/08

(52) U.S. Cl. CPC C25B 11/02; C25B 9/23; C25B 9/70; C25B 11/031; C25B 11/056; C25B 11/061; C25B 11/089; C25B 13/08

(57) ABSTRACT

An electrolyser (200) comprising: a cathode structure comprising a first PCB plate (202) and an electrically conductive substrate (220); an anode structure comprising a second PCB plate (204) and an electrically conductive substrate (220); an anion exchange membrane (218) located between the cathode structure (202) and the anode structure (204); two transport layers, (214, 216), one transport layer (216) disposed between the anode structure (204) and the anion exchange membrane (218) and one transport layer (214) disposed between the cathode structure (202) and the anion exchange membrane (218); and at least one fluid path to supply an electrolyte to the electrolyser (200).

The present invention relates to electrolysers, AEM electrolysers, AEM electrolyser apparatus for the production of hydrogen, electrolyser stacks, the use of an electrolysers and electrolyser stacks for the production or generation of hydrogen, methods of generating hydrogen, methods of manufacture of electrolysers and use of PCB plates in electrolysers and electrolyser systems.

The present inventions have particular application to the generation of hydrogen, particularly green hydrogen production.

### BACKGROUND

An electrolyser is a device in which electrolysis occurs, where an electrolyte is decomposed as part of a chemical reaction at electrodes, driven by an electric current passed through the electrolyte via the electrodes. Without the current the reaction would be non-spontaneous.

The electrolyte decomposes due to ionization. An electrolyte is a chemical substance which contains some free ions and carries electric current (e.g. an ion-conducting polymer, solution, or an ionic liquid compound). Due to the need for the free flow of ions, electrolysis cannot occur in solid state materials, so an electrolyte can be i) melted or in a molten state, ii) an aqueous solution created by solvation or reaction of an ionic compound with a solvent (such as water) to produce the necessary mobile ions, or iii) water. For example, in electrolysis of molten NaCl, chlorine gas forms at the anode, and deposits of metal sodium form at the cathode. For example, in electrolysis of water, at the cathode hydrogen bubbles are formed and at the anode oxygen bubbles form, as water electrolysis is the splitting of water molecules into hydrogen and oxygen.

Electrodes are connected to a power source and immersed in the electrolyte. Each electrode will attract ions of the opposite charge, effectively electrons are introduced at the cathode as a reactant and removed at the anode as a product. Electrodes are typically graphite, metal or semiconductor materials, and choice will vary based on cost, supply and level of reaction with the electrolyte of choice. Non or low reactivity materials such as graphite and platinum are typically chosen.

Two electrolysis technologies are particularly prevalent and are focused on as showing promise for the much needed implementation of green hydrogen production on larger a scale. These are alkaline water electrolysis (AWE) and proton exchange membrane water electrolysis (PEMWE). They differ in the electrolyte used-AWE uses an alkaline solution as the electrolyte, PEMWE utilises a solid membrane electrolyte. Typically, AWE has the disadvantage of only being able to operate a low current densities and pressure, whilst PEMWE can act at a higher load, with higher energy densities and efficiencies. However, PEMWE is typically much more expensive than AWE.

Proton Exchange Membrane (PEM) Water Electrolysis (PEMWE) is the electrolysis of water in a system or device which has a solid polymer electrolyte (SPE). The SPE is located in between the anodes and the cathodes. A proton-exchange membrane (or polymer-electrolyte membrane, also PEM), is a membrane generally made from ionomers which can conduct protons across the membrane. The PEM also acts to electrically insulate the anode and the cathode and as a barrier to the reactants and resultant products (e.g. water and gases produced, H₂ and O₂).

An alternative to PEM electrolysis technology is anion exchange membrane (AEM) electrolysis technology, AEM electrolysers. An anion exchange membrane (AEM) is a membrane generally made from ionomers which can conduct anions (e.g. OH-ions in a hydroxide anion exchange membrane) across its membrane, analogous to how Proton Exchange Membranes (PEM) conduct protons across a membrane. These also act to separate the anode and the cathode, electrically insulate the anode and the cathode from each other and as a barrier to the reactants and resultant products (e.g. water and gases produced, H₂ and O₂). AEM electrolysers typically operate in a weakly alkaline environment (PH˜10), for example using a 1% potassium hydroxide (KOH) water electrolyte. AEM electrolysers may have a catalyst containing layer or catalyst present somewhere on either side of the AEM, then Gas Diffusion Layers (GDLs) or transport layers either side of the AEM over or comprising the catalyst containing layers.

In an AEM electrolyser water is supplied to the cathode side, or the anode side, or both the anode and cathode sides, and the power supplied by an external circuit creates an electrical potential difference at the interface of the electrolyte and electrode. This drives the hydrogen evolution reaction (HER) by means of electron (e⁻) transfer (e.g. 4H₂O+4e⁻→4OH⁻+2H₂). Hydroxide ions OH⁻ produced in the HER are transferred across the AEM and react at the anode side of an AEM electrolyser, consumed by the oxygen evolution reaction (OER): 4OH⁻→2H₂O+O₂+4e⁻. The OH⁻levels in the electrolyte remain constant and water can be constantly supplied without the need for additional KOH.

AEM electrolysis technologies have the combined benefits of PEM and AWE as they are cost effective by utilising non-noble catalysts, but also achieve high energy densities and efficiencies comparable to PEM technology.

Compared to PEM electrolysis, AEM electrolysis is also a less corrosive environment, so cheaper metals can be used both for catalysts and other components such as the flow field plates. PEM electrolyser typically require platinum group metal catalysts and expensive titanium bipolar plates to not corrode in the corrosive acidic environment.

When compared to alkaline electrolysis, AEM electrolysis has higher energy densities and efficiencies comparable to PEM technology. Further, the use of the more compact solid electrolytes means that AEM electrolysers can be more compact than AWE electrolysers, so when stacking can result in higher current densities. AEM electrolysers can also have faster response times, which is beneficial when being used with renewable energy sources. The use of more dilute alkaline solutions also has safety benefits, not requiring the use of pH 14 electrolytes also renders anion exchange membrane (AEM) electrolysis technology safer than alkaline electrolysis. AEM electrolysis is also less prone to carbonate precipitation on electrodes.

FIG. 1 shows a system 100 set up for and around an AEM electrolyser 102. System 100 comprises AEM electrolyser 102. The electrolyser 102 comprises a cathode 104 half and an anode 106 half. The electrolyser 102 is powered by power supply 108, providing the electrical power necessary to drive an electrolysis reaction. Heater 110 heats the electrolyser 102 to increase electrolysis speed, whilst heat exchanger 112 can recover heat from the various fluids to optimise performance of the electrolyser 102. Diaphragm pump 114 moves the fluids around the system 100 and can act to pressurise the gases produced from the electrolyser 102. Liquid-gas separator 116 separates the produced gases from the liquid electrolyte/water, separating the hydrogen 122 and oxygen 124. The produced gases hydrogen 122 and oxygen 124 are passed through pressure regulator valves 120 to regulate their pressure. Pressure relief valves 118 are also present, if necessary. From the liquid-gas separator 116, hydrogen can be stored, pressurised, and/or transported to where it is needed.

AEM electrolysis has shown promise in the renewable energy sector for enabling efficient energy conversion and storage. An alkaline environment, particularly one weaker than that utilised for AWE technologies is suitable for a large range of materials with good chemical stability under the operating conditions such processes occur. Green hydrogen can be produced through electrolysis, separating water into hydrogen and oxygen, possibly using electricity generated from renewable sources. Alkaline electrolysers could generate hydrogen for fuel cells to utilise.

AEM is an emerging technology and given the need for green hydrogen in a net zero economy, scaling manufacture is critical.

Present AEM electrolysers are typically made of metal plates, formed of several layers. They are expensive to manufacture to scale and can lack customisability. There is a need to improve the efficiency of these electrolysers, which should result in their more widespread use. Any means to increase efficiency of these would be welcomed by the industry.

In view of the foregoing, it is desirable to provide improved, efficient and scalable AEM technologies. It is desirable to provide improved AEM electrolysers, improved methods of generating hydrogen and improved manufacture of AEM electrolysers.

### SUMMARY

According to a first aspect, there is provided an electrolyser. The electrolyser comprises: a cathode structure comprising a first PCB plate and an electrically conductive substrate; an anode structure comprising a second PCB plate and an electrically conductive substrate; an anion exchange membrane located between the cathode structure and the anode structure; two transport layers, one transport layer disposed between the anode structure and the anion exchange membrane and one transport layer disposed between the cathode structure and the anion exchange membrane; and at least one fluid path to supply an electrolyte to the electrolyser. Preferably, the electrolyser is an anion exchange membrane water electrolyser, for the production of hydrogen.

Present and known AEM electrolysers are typically made of metal plates, formed of several layers. They are expensive to manufacture to scale and can lack customisability.

Surprisingly the inventors have found that PCBs can be utilised to produce high performing electrolysers. The construction of the present alkaline electrolysers is unique being a PCB structure. This has a clear manufacturing advantage from a supply perspective. The manufacture cost per cm³ will be significantly lower than electrolysers of the art, for example metal electrolysers. These electrolysers can be manufactured on a PCB line with no modification to materials or manufacturing equipment required. Plates can easily be manufactured in bulk, with advantageous manufacturing techniques such as plates being able to be stacked and drilled. The same plate design can be used for the anode and the cathode plate, which is advantageous in manufacture. Alternative, different plate designs, e.g. layers or positioning of metal plating or flow paths, can be applied to the present embodiments.

PCB manufacture techniques are far more customisable than traditional manufacture techniques, allowing for bespoke and customisable designs of the electrolysers, to suit various situations. Designs can be quickly altered.

The electrolysers described herein can operate at typical operating temperatures of alkaline electrolysers, for example between 50° C. and 80° C.

Further, electrolysers of the art are bulky metal constrictions with mechanical sealing. The herein described electrolysers are lightweight, which is particularly advantageous in certain applications. They also remove the need for complicated and expensive mechanical sealing techniques, the PCB electrolysers descried herein may be laminated. The PCB electrolysers descried herein may be sealed as described herein, for example with prepreg.

The use of PCB plates in the manufacture of alkaline electrolysers allows for an inherently sealed design, using compression sealing. This increases ease of manufacture and safety of electrolysers.

There is also a question of efficiency with currently known AEM electrolysers, which can be addressed with the present designs and ability to iterate flow field designs quickly.

Preferably, the first PCB plate and/or the second PCB plate comprise a copper plated layer disposed on the PCB plate and comprise a nickel plated layer disposed on top of the copper plated layer. This may be referred to as a ‘current collector’ layer, as it must be conductive to allow an electric current to flow. Rather than copper, an additional layer, coating, deposit or current collector layer could be added which functions to replace the copper. As described in the Examples later, nickel was found by the inventors to have increased stability in KOH.

Preferably, the electrically conductive substrate of the cathode structure and the anode structure comprises metal. Preferably, copper and/or nickel or an alloy of copper and/or nickel, preferably nickel coated copper, ENIG coated copper, conductive epoxy coated copper, HASL coated copper, nickel-phosphorus coated copper or carbon coated copper.

Preferably, at least one of the first PCB plate and the second PCB plate are routed to comprise a fluid flow path for the electrolyte. This routing may be depth routed in a PCB plate, preferably at least one fluid flow path is formed within at least one PCB layer such that the fluid flow path is routed or grooved within the PCB layer without the routing or groove extending all the way through the PCB plate. This ensures that the electrolyte has a flow path or a channel to the desired reaction areas (in contact with the transport layers), but does not flow out of the electrolyser or in any unwanted directions/areas. The ability to manufacture and customise PCB plates to have desired and customisable depth routed flow paths is an advantage of this PCB technology, it is harder and more expensive to achieve on metal plates, metal plates are less customisable. Preferably, the fluid flow path directs the electrolyte to the nickel plated layer disposed on top of the copper plated layer on the first PCB plate and the second PCB plate.

Preferably, at least one fluid flow path is formed within at least one PCB layer such that the fluid flow path is routed or grooved within the PCB layer without the routing or groove extending all the way through the PCB plate.

Preferably, the fluid flow path directs the electrolyte to the nickel plated layer disposed on top of the copper plated layer on the first PCB plate and the second PCB plate.

Preferably, the first PCB plate and second PCB plate have at least one fluid inlet and at least one fluid outlet drilled extending all the way through the PCB plate. Preferably, the outlet is the same size as the inlet.

Preferably, the electrolyte comprises KOH and/or NaOH.

Preferably, the transport layers are porous transport layers. Preferably, the transport layers comprise a catalyst, preferably the catalyst on the cathode side is selected from the group consisting of MoCa, Pt black, Pt/C, Ni—Mo, or alloys of these metals, and the catalyst on the anode side is selected from the group consisting of NiFe, Iridium oxide, Copper cobalt oxides or Nickel cobalt oxides. Preferably the transport layers comprise nickel as a Felt, nickel as a mesh or nickel foam, or alloys of nickel, or Zirconium.

Preferably, the anode transport layer and cathode transport layer are located adjacent the current collector area of the PCB plate.

Preferably, the anion exchange membrane comprises Fuma-tech fumasep, Dioxide Materials Sustainion, Orion polymer membranes, Xergy, Ionomr Aemion or Tokuyama A201.

Preferably, the electrolyser further comprises end plates and/or current collection plates/current collectors. These may be disposed either side of the anode and cathode plates to encase or house the electrolyser.

Preferably, the electrolyser further comprises housing. Housing may contain the herein described components, other components, or means to link the electrolyser to other electrolysers or wider system components. The housing may be or may comprise end plates or current collectors.

Preferably, the electrolyser further comprises an anode chamber and a cathode chamber suitable for fluid flow of the electrolyte. These chambers may be formed by the depth routing of the PCB plates as described herein, optionally in combination with the other components and the sealing described herein, enclosing the chamber.

Preferably, the electrolyser has a power consumption of up to 50 kW, preferably up to 40 KW, preferably up to 30 kW, preferably up to 20 KW, preferably up to 10 kW, preferably up to 5 KW, preferably up to 4 kW, preferably up to 3 kW, preferably up to 2 kW, preferably up to 1 kW. Further, preferably each electrolyser has a power consumption of 1 kW to 5 kW, preferably 1 kW to 10 KW, preferably 1 kW to 15 kW, preferably 1 kW to 20 kW, preferably 1 kW to 30 kW, preferably 1 kW to 40 kW, preferably 1 kW to 50 kW. Preferably, multiple electrolysers of the sizes described herein can be stacked together to have a total power consumption of for example up to 30 kW.

Preferably, the electrolyser is laminated together, preferably by heat bonding layers of sealing between the PCB plates under an increase temperature. This ensures the electrolyser is sealed Use of lamination with for example an epoxy resin prepreg also maintains compression of the layers, which can be an important component in maintaining electrolyser performance, without compromising distribution of reactant fluids.

According to a further aspect, there is provided an electrolyser apparatus for the production of hydrogen, the electrolyser apparatus comprising an electrolyser as described in the above preferably described electrolysers, or other electrolysers described herein or above.

According to a further aspect, there is provided an electrolyser apparatus for the production of hydrogen, the electrolyser apparatus comprising multiple electrolysers as described in the above preferably described electrolysers, or other electrolysers described herein or above.

This may be an electrolyser stack, which may comprise multiple electrolyser cells as describe herein arranged as a stack, in order to produce a greater rate of hydrogen production. Such a stack may include between two cells and two hundred cells, more typically between eight cells and one hundred cells. Such a stack may comprise housing. Such a stack may comprise end plates and/or current collectors. The stack may comprise electronic means to control operation of the stack, or other such electrical or control modules and/or components.

According to a further aspect, there is provided the use of an electrolyser of any one of the electrolysers described herein or above, or the electrolyser apparatus or stacks described herein or above, to generate hydrogen.

According to a further aspect, there is provided a method of generating hydrogen, the method comprising using an electrolyser of any one of the electrolysers described herein or above, or the electrolyser apparatus or stacks described herein or above, to generate hydrogen.

According to a further aspect, there is provided a method of manufacture of an electrolyser, the method comprising laminating two or more PCB boards to make an electrolyser.

Preferably, plates and electrolyser components may be sealed together to form the electrolyser. Plates may be sealed together using known PCB sealing methods, for example PCB layers may be sealed with an epoxy resin prepreg (herein ‘prepreg’). In construction of an electrolyser the components may be sealed with layers of prepreg between the different layers, with layers then laminated together.

Use of a sealing materials such as prepreg, and the use of PCB materials, ensures that the electrolyser is sealed from anything not deliberately directed to the components of the electrolyser by the inlets/channels/flow fields in the PCB boards (e.g. anode and cathode plates) directly adjacent to the internal electrolyser components. This is an advantage of the PCB technology, it allows quick, simple and cheap construction of such structures. Use of lamination with for example an epoxy resin prepreg also maintains compression of the layers, which can be an important component in maintaining electrolyser performance, without compromising distribution of reactant fluids.

Preferably, the method may involve involving careful pre-cutting and alignment of materials, along with bespoke heating, cooling, pressure and washing cycles.

Preferably, mechanical seals could be used additionally to seal the electrolysers, particularly for electrolysers which will operate a higher pressures.

Preferably, before sealing, plated through holes can be drilled into the plates, along with inlet and outlet holes or other holes for bolting could be drilled or routed.

Preferably, possibly due to the elevated pressures and/or temperatures at which the herein described electrolysers may be operated at, alternative sealants to prepreg may be used, for example Ethylene Propylene Diene Rubber Monomer (EPDM), polyvinylidene fluoride (PVDF) or fluoroelastomers can be used.

According to a further aspect, there is provided the use of PCB plates as electrodes in an electrolyser. Preferably, this electrolyser produces hydrogen. Preferably, this hydrogen is produced on a scale described here.

According to a further aspect, there is provided the use of PCB plates in an electrolyser. Preferably, this electrolyser produces hydrogen. Preferably, this hydrogen is produced on a scale described here.

According to a further aspect, there is provided an electrolyser system comprising an electrolyser of any one of the electrolysers described herein or above, or the electrolyser apparatus or stacks described herein or above. The system may comprise a power supply, providing the electrical power necessary to drive an electrolysis reaction. The system may comprise a heater to heat the electrolyser, e.g. to increase electrolysis speed. The system may comprise a heat exchanger to recover heat from the various fluids, e.g. to optimise performance of the electrolyser. The system may comprise one or more means to cool the stack. The system may comprise a pump for example a pump to move fluids around the system, and/or to pressurise the gases produced from the electrolyser. This may be a diaphragm pump or another such pump. The system or electrolyser within a or the system may self-pressurise the gases produced from the electrolyser. This may be when electrolyte is pumped on the non-gas producing side of the electrolyser. The pressure of the gases produced may be for example up to 30 bar, or more. The system may comprise a liquid-gas separator to separates the produced gases from the liquid electrolyte/water, e.g. separating the hydrogen and oxygen. The system may comprise pressure regulator valves, where the produced gases hydrogen and oxygen are passed through pressure regulator valves to regulate their pressure. The system may comprise also pressure relief valves. From a liquid-gas separator, hydrogen can be stored, pressurised, and/or transported to where it is needed. The system may comprise a dryer to absorb water. The system may comprise means to store hydrogen or other gases.

Preferably, this electrolyser produces hydrogen. Preferably, this hydrogen is produced on a scale described here.

Any the preferably components of the first electrolyser aspect described may be applied to the other aspects described herein.

### BRIEF DESCRIPTION OF THE DRAWINGS

Specific embodiments of the invention will now be described by reference to the accompanying drawings, in which:

FIG. 1 shows a schematic of an electrolyser system;

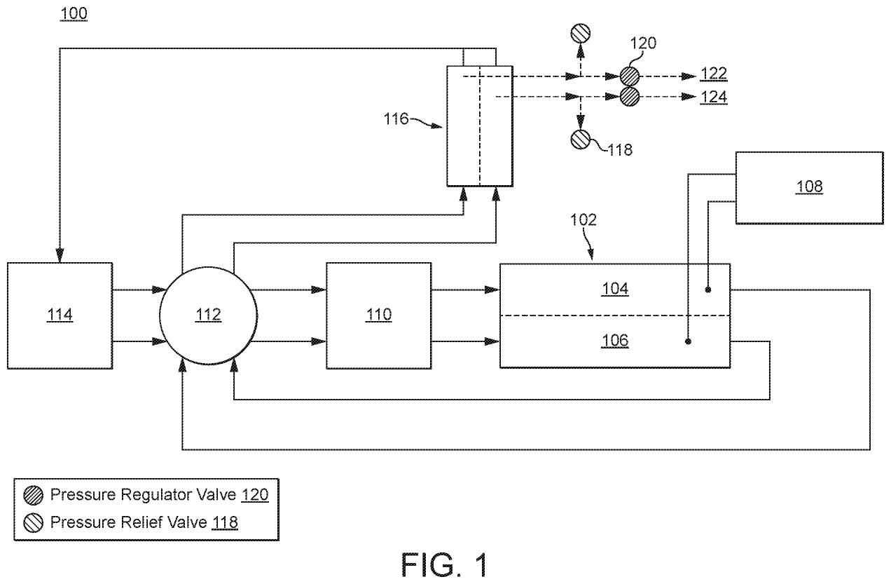

FIG. 2 shows a schematic exemplary embodiment of an AEM electrolyser;

FIG. 3 shows an exemplary PCB plate;

FIG. 4 shows an electrolyser with end plates and current collectors;

FIG. 5 shows an AEM electrolyser as part of an electrolyser system;

FIG. 6 shows a polarisation curve for PCB AEM Electrolyser;

FIG. 7 shows the polarisation curves of the PCB AEM Electrolyser at different concentrations and temperatures; and

FIG. 8 shows a reference polarisation curve at 60° C.

### DETAILED DESCRIPTION

Embodiments will now be described in detail with reference to the accompanying drawings. The same reference signs indicate the same or similar features in different figures and embodiment of the invention, although this is only for reference and is not limiting on the invention. In the following detailed description numerous specific details are set forth by way of examples, in order to provide a thorough understanding of the relevant teachings. However, it will be apparent to one of ordinary skill in the art that the present teachings may be practiced without these specific details.

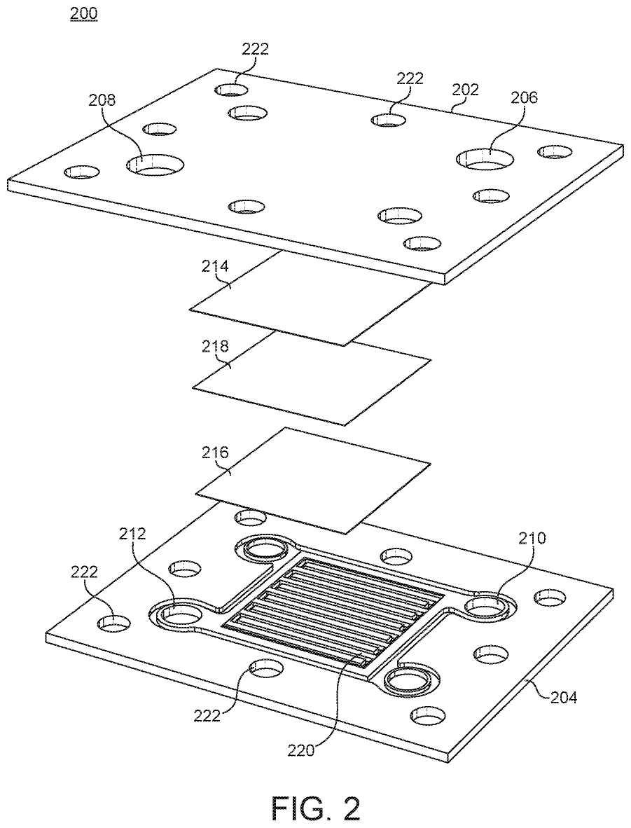

FIG. 2 shows an electrolyser 200 or electrolyser cell 200 according to an embodiment. This is a 25 cm² PCB AEM electrolyser. Electrolyser 200 is a stackable

PCB electrolyser comprising nickel coated PCB plates for use in a KOH electrolyte solution, as described herein.

Electrolyser 200 comprises two PCB plates 202, 204, which are cathode plate 202 and anode plate 204. These PCB plates sandwich the other components of the electrolyser 200. These act as the cathode and the anode in the electrolyser.

In this and other embodiments described herein, PCB plates may be produced in the known way. Insulating core layers may be made of dielectric substrates such as FR-1, FR-2, FR-3, FR-4, FR-5, FR-6, CEM-1, CEM-2, CEM-3, CEM-4, CEM-5, polytetrafluoroethylene, and G-10, preferably core layers are be made of or comprise FR-4. Layers may be laminated together with an epoxy resin prepreg. In order to yield conductive areas, or conduction between PCB layers, a thin layer of copper may either be applied to the whole insulating substrate and etched away using a mask to retain the desired conductive pattern, or applied by electroplating. The PCB plates may have plated through holes (PTHs), copper through holes which allow conduction of electrical current from one face of the plate to another.

In embodiments, PCB materials may benefit from a coating to improve stability in the alkaline conditions that the herein described electrolysers operate in. Copper, the most commonly used metal in PCB manufacturing is often used for conducting current across different layers in the PCB, but will corrode in alkaline solutions, particularly at high(er) potentials. Thus, the copper benefits from protection in some way. The PCB components or specifically the exposed copper areas may be coated or plated with a further layer on top of the copper. This may be referred to as a ‘current collector’ layer, as it must be conductive to allow an electric current to flow. Rather than copper, an additional layer, coating, deposit or current collector layer could be added which functions to replace the copper. As described in the Examples later, nickel was found by the inventors to have increased stability in KOH. The cathode current collector layer used in electrolyser 200 is nickel plated copper the anode current collector layer used in electrolyser 200 is nickel plated copper. These plates 202, 204 are FR4 sheet sheets with copper either side, then nickel is added on a side (or both sides) in a plating process.

For an anode this additional layer, coating, deposit or current collector layer could be or comprise nickel, a nickel alloy, nickel coated copper, Electroless nickel immersion in gold (ENIG) coated copper, conductive epoxy coated copper, hot air solder levelling (HASL) coated copper or nickel-phosphorus coated copper.

For a cathode this additional layer, coating, deposit or current collector layer could be or comprise nickel, a nickel alloy, nickel coated copper, Electroless nickel immersion in gold (ENIG) coated copper, conductive epoxy coated copper, hot air solder levelling (HASL) coated copper, nickel-phosphorus coated copper or carbon coated copper.

ENIG has the advantage of using relatively cheap (relative to gold) nickel as a bulk conductor that also has relatively low contact resistance with a thin layer of gold over the top which prevents oxide layer formation (and thus maintains a low contact resistance with time) between cells and to electrical terminals.

HASL is a layer of molten solder which coats all the copper surfaces and enables electrical contacts to be easily made. Relative to ENIG HASL has a lower planarity but is cheaper relative to ENIG.

There may additionally or instead be a non-metallic conductive (protective) layer added, e.g. screen printed, (i.e. a carbon based ink, or conductive epoxy resin).

The current collector layer is located in the region central of the anode plate 204 and cathode plate 202, adjacent where the anode transport layer 216 and cathode transport layer 214 are located, so that the current collector layers are adjacent to the anode transport layer 216 and cathode transport 214 layer. This is so the plated area interfaces with the PTLs. In the embodiment seen in FIG. 2 this is a square shape, but the shape could change based on ensuring an equivalent surface area to the anode transport layer 216 and cathode transport layer 214, as well as the anion exchange membrane 218. Under the nickel current collection layers is the copper plating of the PCB plates 202, 204.

Due to the plating on these plates 202, 204, when an electrical current is directed to a plate, a plate can act to transport current to the electrolyser, specifically electrons to the cathode. The copper on the outer face of 202 is electrically connected via PTHs in the PCB to the inner surface of the plate which is coated in nickel. Due to the choice of coating, these PCB plates 202, 204 are non-reactive so do not degrade over time. This current collection area is the “reaction” site for the AEM electrolyser, as all components necessary for the reactions are present.

The PCB plates 202, 204 may have copper, copper plated nickel or some other conductive material deposited on the edge of the plates, in order to test the voltage on the plate or for a connection to an external power source to power the electrolyser reactions. The plates may additionally or instead have a tab or exposed point which has copper, copper plated nickel or some other conductive material deposited on the edge of the plates, in order to test the voltage on the plate or for a connection to an external power source to power the electrolyser reactions.

These PCB plates 202, 204 are depth routed with flow fields 220 to ensure that the liquid electrolyte introduced to the plate is able to be evenly distributed to the internal components of the electrolyser. In FIG. 2 a serpentine flow field 220 is visible only on anode plate 204. An identical flow field is also found on cathode plate 202, but is not visible in FIG. 2 because the field is not drilled or routed through the whole depth of the plate, it is only to partial depth (hence “depth routed”). These flow fields are a channel through which liquid flows from the plate inlet to the plate outlet. Gas generated at the electrodes may also flow out of the plates via these flow fields to the outlets.

For this embodiment, the serpentine pattern of the flow field 220 is only exemplary. Other patterns could be used for the flow fields in this or other embodiments herein. The flow field pattern in this embodiment is identical for both the anode plate 204 and the cathode plate 202, but the pattern in this or other embodiments herein could be different depending on flow need.

The PCB plates 202, 204 shown here, but also for all embodiments, have holes 206, 208, 210, 212, 222 drilled or routed through the whole body of the plates. In FIG. 2, cathode outlet 206, cathode inlet 208, anode outlet 210 and anode inlet 212 are all labelled. Further holes 222 are also labelled, only 2 of the 8 of these holes on both the cathode plate 202 and the anode plate 204 are labelled. Using routed or drilled holes mean that the plates are easily, quickly and cheaply manufacturable. The plates are drilled for two primary reasons: i) inlet 208, 212 and outlet 206, 210 holes to distribute reactants and products through each cathode plate 202 and anode plate 204 in an electrolyser cell 200 to the enclosed layers e.g. the electrodes and the catalysts, as well as to and from end plates (not shown in FIG. 2), where end plates can have fittings that distribute the fluids/gas into and out of the wider system; and ii) to provide holes 222 where locations where bolts or other such holding means can hold electrolyser cells 200 together for sealing and compression purposes. These holes 222 can be for alignment and/or compression, and/or ultimately fixing, of end plates.

Generally, there are multiple designs of this PCB plates that are appropriate, the drilling or routing through the whole body of the PCB plate to create the flow fields or channels could be in any pattern or design which ensures correct passage of fluids and/or fixation or bolt locations.

Generally, inlet and outlet holes on AEM electrolyser plates are kept as large as possible to ensure a minimal pressure drop across a plate, and thus a stack.

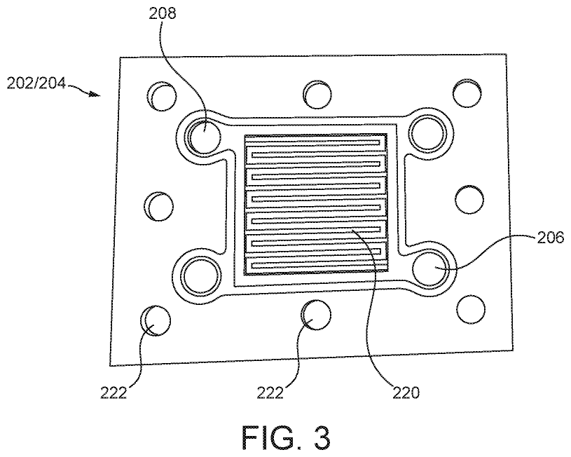

The plate 202/204 in FIG. 3 has four holes which could be inlet or outlet holes, only two are labelled as outlet 206 and inlet 208 in FIG. 3, the other two holes are not utilised as the inlet/outlet but are to distribute electrolyte flow to the other plate in an electrolyser/stack, i.e. if this was an anode plate, to the cathode plate.

The electrolyser could further comprise a separate outlet, for outlet of gas alone. Positioned in a spot, for example top centre, to ensure gases could be vented off from the electrolyser.

Electrolyser 200 comprises a cathode transport layer 214 and an anode transport layer 216. These are porous so are sometimes known as porous transport layers (PTLs). The cathode transport layer 214 in electrolyser 200 is NiFe on Nickel felt and the anode transport layer 216 in electrolyser 200 is MoCa on Carbon felt.

Generally, the transport layers act to allow transport ions generated at the electrodes across the anion exchange membrane (AEM) to the other side of the electrolyser. Here, they allow the transport of the hydroxy OH⁻ ions generated at the cathode across the AEM to the anode side of the electrolyser. They also allow thermal conduction through the electrolyser. Variations in their material properties can effect the electrolysis reaction rate and efficiency.

In this and other embodiments described herein, the cathode transport layer and the anode transport layer may comprise or be made from other materials. The anode transport layer may comprise or be made from Ni Felt, Ni mesh, Ni sintered powder, stainless steel felt, stainless steel mesh or stainless steel powder. The cathode transport layer may comprise or be made from Ni Felt, Ni mesh, Ni sintered powder, stainless steel felt, stainless steel mesh, stainless steel powder or carbon coated copper. Preferably transport layers are high surface area materials and made from a material such as nickel which can act as a catalyst for the reaction to take place at the electrodes. A high surface area ensures a higher reaction rate. Transport layers act to facilitate transport of water, gas, electrolyte and electrical current. Current and water/electrolyte is needed at any reaction site on the PTL as it drives the reaction. A suitably porous PTL will also facilitate the effective removal of produced gas such that more electrolyte can react at the reaction site once a product gas bubble is formed.

Further, transport layers made be made from or comprise a PCB. Complex 3D geometries can be achieved with PCB materials, due to their controllable manufacture techniques. For example, a nickel PCB plate with hole geometries could be utilised as transport layers, or for example, stacked PCB layers of nickel coated plates with hole geometries could be utilised as transport layers. These could act like a nickel mesh with FR4, optionally also with copper plating, as an intermediate layer.

The transport layers 214, 216 are coated/loaded with a catalyst (not visible in FIG. 2). The cathode catalyst used in electrolyser 200 is MoCa and the anode catalyst used in electrolyser 200 is NiFe. In this and other embodiments described herein, the catalysts may comprise or be made from other materials. The cathode catalysts may be MoCa (typical loading 4 mg cm⁻²), Pt black, Pt/C, Ni—Mo, or alloys of these metals. The anode catalysts may be NiFe (typical loading 4 mg cm⁻²), Iridium oxide, Copper cobalt oxides, Nickel cobalt oxides, or alloys of these metals.

The type of catalyst chosen may determine which side of the electrolyser will react as the anode and which side will act as the cathode. All other components may be identical, such as plate geometry, transport layer material etc., whilst the catalysts may differ to determine which reaction is that of the anode and which is that of the cathode. Other factors may also alter symmetry of the two halves of the electrolyser, such as the materials chosen for the transport layers, to determine which side acts as an anode and which side acts as a cathode.

Because the transport layers 214, 216 are typically made of a material such as nickel which can act as a catalyst for the reaction to take place at the electrodes catalyst is not essential for the electrolyser to function. A high surface area metal such as nickel transport layer may ensure a reaction of a sufficient rate can take place at the electrodes.

The cathode transport layers 214 and anode transport layer 216 sandwich the anion exchange membrane 218. The anion exchange membrane 218 in 200 is Sustainion.

The anion exchange membrane 218 comprises a solid electrolyte layer, which can conduct anions (e.g. here OH ions in a hydroxide anion exchange membrane) across the membrane 218. The solid electrolyte layer 218 separates the anode plate 204 and the cathode plate 202, electrically insulates the anode plate 204 and the cathode plate 202 from each other, and acts as a barrier to the reactants and resultant products.

In this and other embodiments described herein, the anion exchange membrane may comprise or be made from other materials. The anion exchange membrane may comprise or be made from Fuma-tech fumasep, Dioxide Materials Sustainion, Orion polymer membranes, Xergy, Ionomr Aemion or Tokuyama A201.

The liquid electrolyte utilised with the electrolyser 200 is Potassium hydroxide (KOH) solution in water. Potassium hydroxide suitable will range between 0.1 and 1M, preferably around 0.5M. Pure water, or any basic or alkaline solution known in the art may be utilised with the presently described electrolysers, for example if an alkaline solution is to be used this may be KOH or NaOH in a concentration between 0.1M and 1M.

FIG. 3a shows an exemplary PCB plate 202/204 of an embodiment, the same plate as cathode plate 202 and anode plate 204 in electrolyser 200 in FIG. 2. This plate could be an anode plate 204 or a cathode plate 202. This is a 25 cm² PCB AEM electrolyser plate. Flow field 220 is clearly visible and central in the plate 202/204. Holes 206, 208, 222 are drilled or routed through the whole body of the plate. Plate outlet 206, and plate inlet 208 are all labelled. Further holes 222 are also labelled, only 2 of the 8 of these holes on the plate 202/204 are labelled.

Depth routed flow field 220 is visible in the plate 202/204 which is the fluid flow field, fluid flow path or fluid flow channel (terms interchangeable) of this plate 202/204. This is where the electrolyte will flow from the fluid inlet 208 and out of the outlet 206. For this embodiment, the serpentine pattern of the flow field 220 is only exemplary. Other patterns could be used for the flow fields in this or other embodiments herein. The flow field pattern in this embodiment is identical for both the anode plate 204 and the cathode plate 202, but the pattern in this or other embodiments herein could be different depending on flow need.

Electrolysers of this embodiment, and other embodiments described herein, comprise at least one first fluid path to supply an electrolyte to the electrolyser. There can be a first fluid path to supply the cathode structure and/or a second fluid path to supply an electrolyte to the anode structure, e.g. a first fluid path and a second fluid path, one for the anode plate and one to the cathode plate.

These fluid paths can be the routed area on the cathode or the anode plate, which runs from the inlet, across the plate and out of the plate. This is adjacent to the PCB plates of all embodiments can be routed to comprise one or more fluid flow paths, for the electrolyte. These fluid flow paths can be formed PCB layers or plates such that the fluid flow path is routed or grooved within the PCB layer without the routing or groove extending all the way through the PCB plate. This creates a channel or routed area rather than a hole through the body of the plate. This means that other than the inlets and outlets to the plates, the electrolysers internally are sealed to fluids. The two halves of the electrolyser are also fluidically sealed from each other, because of the presence of the anion exchange membrane and the sealed PCB structure. Routing flow paths into the PCB structures allows control of fluid flow, particularly electrolyte fluid. This means that in this embodiment the fluid flow paths can direct the electrolyte to the nickel plated layer disposed on top of the copper plated layer on the first PCB plate and the second PCB plate. This is adjacent to the transport layer, which may comprise the catalyst, so here the electrolysis will take place.

This could also be structured, or described, as there being an electrolyte chamber at each electrode-one at the anode and one at the cathode. These are fluidically sealed, other than the presence of the inlet(s) and the outlet(s). This chamber can be created due to the depth routing on the PCB plates. The electrolyte will be in contact with the transport layer and the anode/cathode plate, enabling the electrolyser reactions to take place within the chamber. Ions generated can then transport across the AEM.

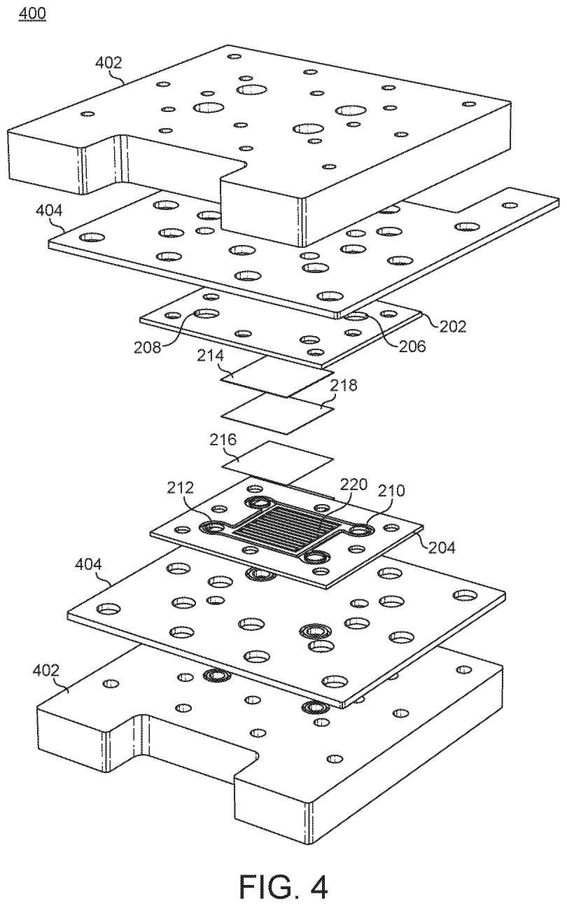

FIG. 4 shows an electrolyser plate with further end plates and further current collectors, with all relevant components from FIG. 2 re-labelled. Further shown in this figure are end plates 402 and current collectors 404. Current collector layers serve to distribute current from a power supply across the entirety of a plate-their desirable properties are to be highly conductive, resistance to corrosion, and to interfere as minimally as possible with the manifolding of the reactant and product fluids. The end plates provide compression for sealing and contact resistance between layers of the electrolyte. The endplates also provide places where pressurised fluid connectors can be mounted to and distribute into the stack.

Multiple electrolysers could be stacked together with such end plates 402 to compress the electrolysers. Endplates can act to compress electrolysers described herein to seal them, to preventing any unwanted any fluid leakage in operation. The compression also reduces contact resistance. Electrolysers can be bolted together to ensure compression.

Plates and electrolyser components may be sealed together to form the electrolyser. Plates may be sealed together using known PCB sealing methods, for example PCB layers may be sealed with an epoxy resin prepreg (herein ‘prepreg’). In construction of an electrolyser the components may be sealed with layers of prepreg between the different layers, with layers then laminated together. Use of a sealing materials such as prepreg, and the use of PCB materials, ensures that the electrolyser is sealed from anything not deliberately directed to the components of the electrolyser by the inlets/channels/flow fields in the PCB boards (e.g. anode and cathode plates) directly adjacent to the internal electrolyser components. This is an advantage of the PCB technology, it allows quick, simple and cheap construction of such structures. Use of lamination with for example an epoxy resin prepreg also maintains compression of the layers, which can be an important component in maintaining electrolyser performance, without compromising distribution of reactant fluids.

Boards which are laminated with a specific lamination process, involving careful pre-cutting and alignment of materials, along with bespoke heating, cooling, pressure and washing cycles.

Before sealing, plated through holes can be drilled into the plates, along with inlet and outlet holes or other holes for bolting could be drilled or routed.

Due to the elevated pressures and/or temperatures at which the herein described electrolysers may be operated at, alternative sealants to prepreg may be used, for example cured prepreg, Ethylene Propylene Diene Rubber Monomer (EPDM), fluoroelastomers, polyvinylidene fluoride (PVDF) or silicones can be used.

In operation or use, the electrolysers described herein can be connected to a power source. An electrolyte can be supplied to the electrolyser, along with or comprising water. The electrolyser will then generate hydrogen gas which can be collected or stored. The energy supplied can be renewable energy and the electrolysers can be part of a green energy system. Multiple electrolysers can be stacked together to increase power density.

Hydrogen generated in the electrolyser is a very pure gas, saturated with water, and its oxygen content doesn't exceed 0.2%. If higher purity is required, the last molecules of oxygen can be removed by catalytic reaction for example in a deoxidizer.

The electrolysers described herein may have power consumption for example between 1 kW and 50 kW, but the modularity of the design enables stacking of multiple electrolysers up to for example a total consumption of 50 kW. However, more electrolysers could be stacked to over 50 kW in total.

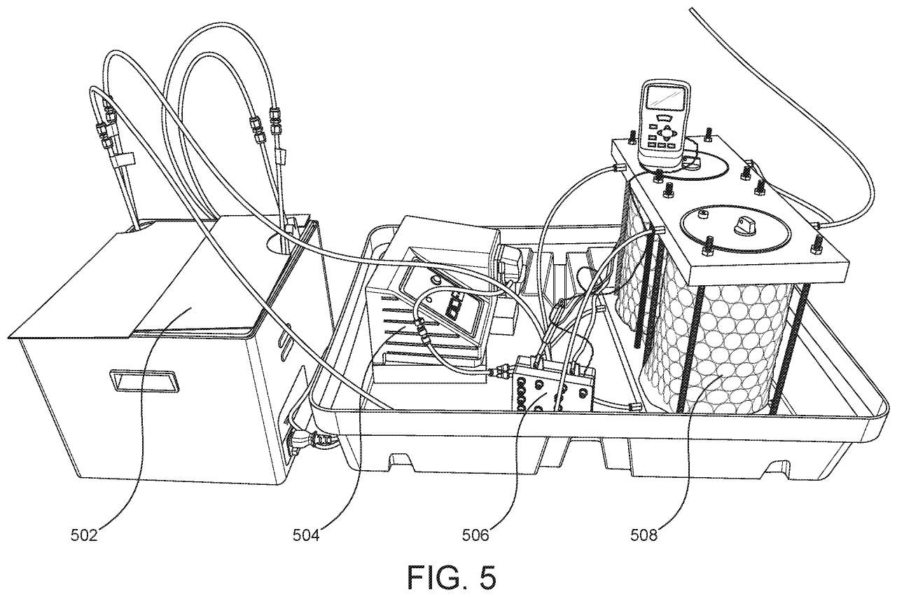

FIG. 5—shows a PCB AEM Electrolyser system. The heat exchanger 502 is a coil of metallic pipes in a heated water bath. Present is a pump 4504. The AEM electrolyser 506 has heating cartridges to control the temperature. The liquid-gas separator 508 consists of sealed tanks with a common liquid reservoir. Not pictured is a power supply, which is typically a potentiostat.

Reference herein to ‘flow’ or ‘flows’ refers to fluids being allowed to flow, or being substantially directed, either with or without assistance, along fluid flow paths, channels or the like.

### EXAMPLES

### Durability

Nickel and carbon coated tabs (comprising a corrosion protection inhibitor and a commercial ink) have been tested in 1M KOH. The carbon coated tabs showed dissolution of the resin into the solution after 48 hours and exhibited a high corrosion current (>40 mA cm⁻² at 2 V, where a more typical value of <1 μA cm⁻² is expected).

The Nickel coated tabs showed stability in 1 M KOH for several months. The corrosion current of these samples was approximately 100 nA cm⁻² at 2 V for 24 hours.

### Performance

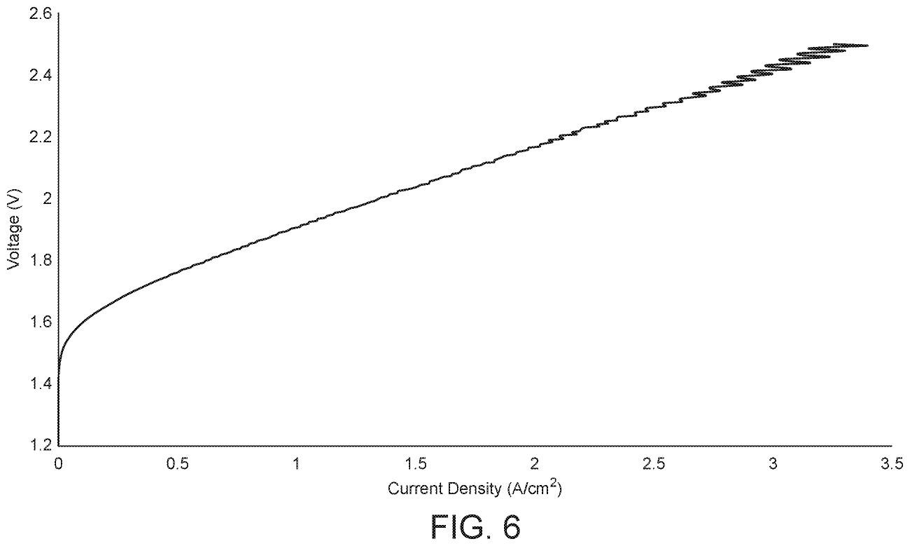

FIG. 6 shows a polarisation curve of the 9 cm2 cell produced up to 3 A cm⁻².

Polarisation curves of the electrolyser were generated using an Ivium XP40 as a power supply. On the cathode, the hydrogen evolution reaction (HER) catalyst was MoCa with a loading of 4 mg cm⁻² on a porous transport layer (PTL) of carbon felt. On the anode, the oxygen evolution reaction (OER) catalyst was NiFe with a loading of 4 mg cm⁻² on a PTL of nickel felt. A Susainion membrane was used in 1 M KOH at 40° C. The flowrate to each electrode was 50 mL min⁻¹, supplied by a Verderflex Vantage 3000 B EZ pump.

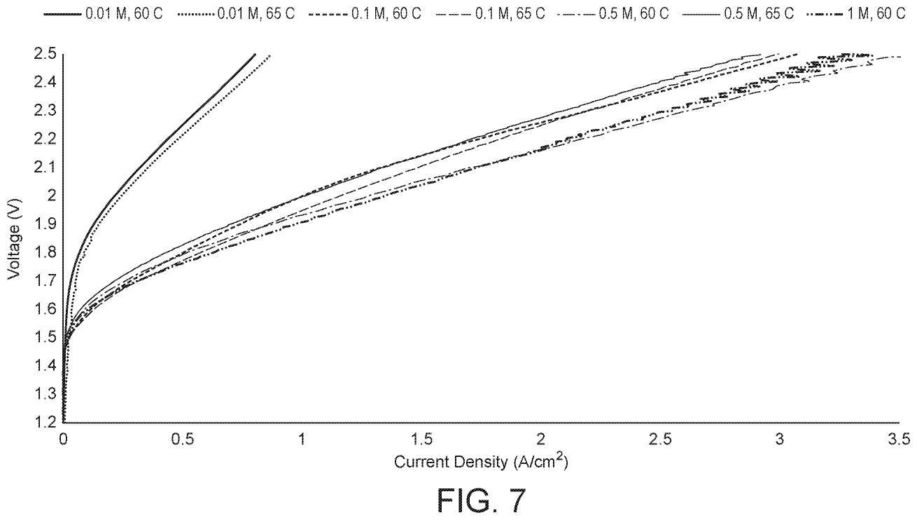

FIG. 7 shows the polarisation curves of the PCB AEM Electrolyser at different concentrations and temperatures. This has also been demonstrated at ambient temperature (data not shown).

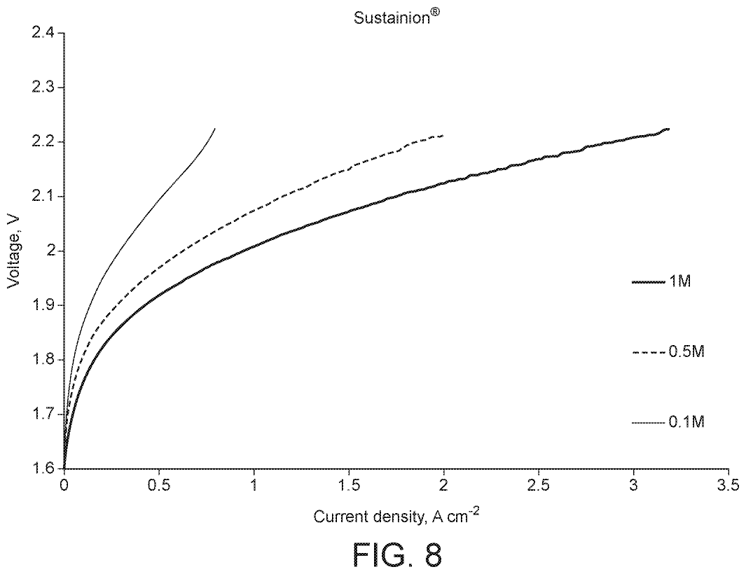

FIG. 8 shows a reference polarisation curve at 60° C. Reference from Pushkareva I. V., Pushkareva, A. S., Grigoriev, S. A., Modisha, P. & Bessarabov, D. G. (2020), Comparative study of anion exchange membranes for low-cost water electrolysis, International Journal of Hydrogen Energy, 45 (49), 26070-26079.

The data presented in FIG. 7 shows near parity with the reference data in FIG. 8, showing that the use of the PCB electrolysers described herein do not cause any drop in performance relative to traditional materials.

The AEM electrolyser was successfully demonstrated and showed expected performance for an electrolyser running below the typical operating temperatures of alkaline electrolysers between 60 and 80° C.

The PCB AEM electrolysers have shown parity with more traditional AEM technologies, and with further optimisation it will be possible to achieve higher performance and hence efficiency of the system. The herein validated designs allow the use of lower concentrations of alkaline solutions may be utilised. Not needing to use higher concentrations of alkaline solutions has the safety and corrosion advantages, plus others, described herein.

Thus, improved AEM electrolysers have been demonstrated.

It will be clear to one skilled in the art that many improvements and modifications can be made to the foregoing exemplary embodiments without departing from the scope of the present disclosure.

1. An electrolyser, the electrolyser comprising:
a cathode structure comprising a first PCB plate and an electrically conductive substrate;
an anode structure comprising a second PCB plate and an electrically conductive substrate;
an anion exchange membrane located between the cathode structure and the anode structure;
two transport layers, one transport layer disposed between the anode structure and the anion exchange membrane and one transport layer disposed between the cathode structure and the anion exchange membrane; and
at least one fluid path to supply an electrolyte to the electrolyser.

2. The electrolyser of claim 1, wherein the first PCB plate and/or the second PCB plate comprise a copper plated layer disposed on the first and/or the second PCB plate and comprise a nickel plated layer disposed on top of the copper plated layer.

3. The electrolyser of claim 2, wherein the electrically conductive substrate of the cathode structure and the anode structure comprises copper and/or nickel or an alloy of copper and/or nickel, preferably nickel coated copper, ENIG coated copper, conductive epoxy coated copper, HASL coated copper, nickel-phosphorus coated copper or carbon coated copper.

4. The electrolyser of claim 1, wherein at least one of the first PCB plate and the second PCB plate are routed to comprise a fluid flow path for the electrolyte.

5. The electrolyser of claim 4, wherein at least one fluid flow path is formed within at least one PCB layer such that the fluid flow path is routed or grooved within the PCB layer without the routing or groove extending all the way through the PCB plate.

6. The electrolyser of claim 4, wherein the fluid flow path directs the electrolyte to the nickel plated layer disposed on top of the copper plated layer on the first PCB plate and the second PCB plate.

7. The electrolyser of claim 1, wherein the first PCB plate and second PCB plate have at least one fluid inlet and at least one fluid outlet drilled extending all the way through the PCB plate.

8. The electrolyser of claim 7, wherein the outlet is the same size as the inlet.

9. The electrolyser of any preceding claim 1, wherein the electrolyte comprises KOH and/or NaOH.

10. The electrolyser of claim 1, wherein the electrolyser is an anion exchange membrane water electrolyser.

11. The electrolyser of claim 1, wherein the transport layers are porous transport layers.

12. The electrolyser of claim 1, wherein the transport layers comprise a catalyst, preferably the catalyst on a cathode side is selected from the group consisting of MoCa, Pt black, Pt/C, Ni—Mo, or alloys of these metals, and the catalyst on a anode side is selected from the group consisting of NiFe, Iridium oxide, Copper cobalt oxides or Nickel cobalt oxides.

13. The electrolyser of claim 1, wherein the transport layers comprise nickel as a Felt, nickel as a mesh or nickel foam, or alloys of nickel, or Zirconium.

14. The electrolyser of claim 1, wherein the anion exchange membrane comprises Fuma-tech fumasep, Dioxide Materials Sustainion, Orion polymer membranes, Xergy, Ionomr Aemion or Tokuyama A201.

15. The electrolyser of claim 1, wherein the electrolyser further comprises end plates and/or current collection plates.

16. The electrolyser of claim 1, wherein the electrolyser further comprises housing.

17. The electrolyser of claim 1, wherein the electrolyser further comprises an anode chamber and a cathode chamber suitable for fluid flow of the electrolyte.

18. The electrolyser of claim 1, wherein the electrolyser is laminated together, preferably by heat bonding layers of sealing between the first and the second PCB plates under an increase temperature.

19. (canceled)

20. An electrolyser apparatus for the production of hydrogen, the electrolyser apparatus comprising multiple electrolysers of claim 1 stacked together.

21. (canceled)

22. A method of generating hydrogen, the method comprising using an electrolyser of claim 1, to generate hydrogen.

23. A method of manufacture of an electrolyser, the method comprising laminating two or more PCB boards to make an electrolyser.

24. (canceled)
